(19) United States
(12) Patent Application Publication
(10) Pub. No.: US 2021/0073850 A1
(43) Pub. Date: Mar. 11, 2021

(54) REDEMPTION CODE DISTRIBUTION

(71) Applicant: Alibaba Group Holding Limited, George Town, Grand Cayman (KY)

(72) Inventors: Hao WU, Zhejiang (CN); Dacheng Zhao, Zhejiang (CN); Jian Zhou, Zhejiang (CN)

(21) Appl. No.: 16/963,388

(22) PCT Filed: Dec. 25, 2018
(86) PCT No.: PCT/CN2018/123347

§ 371 Date: Jul. 20, 2020

(30) Foreign Application Priority Data
Mar. 12, 2018 (CN) 201810199525.0

(51) Int. Cl. G06Q 30/02; G06F 16/22

(52) U.S. Cl. CPC G06Q 30/0239; G06Q 30/0201; G06Q 30/0236; G06Q 30/0235; G06F 16/2282

(57) ABSTRACT

Provided are method, server and system for distributing redemption code. The method comprises: a merchant sending at least one redemption code data to a server (S102); the server receiving the redemption code data (S104); the server writing a merchant identifier and redemption code character into a first data table as primary key, and the server splitting the first data table into a pre-set number of data sub-tables, and storing the redemption code data into the pre-set number of data sub-tables respectively (S106); the server receiving a distribution request from the merchant, and determining target customers based on the distribution request (S108); and allocating the distribution request and the data sub-tables to sub-servers evenly, and a respective sub-server obtaining the redemption code data from a sub data table that corresponds to this sub-server in accordance with said distribution request, and distributing the obtained redemption code data to said target customers.

### CROSS-REFERENCE TO RELATED APPLICATIONS

This patent application claims priority of Chinese patent application No. 201810199525.0, entitled “Redemption Code Distribution”, filed on Mar. 12, 2018, the content of which is incorporated herein by reference in its entirety.

### TECHNICAL FIELD

Embodiments of the present disclosure relate to the field of information processing, and in particular to a method, server and system for distributing redemption code.

### BACKGROUND

In the traditional sales model, in order to attract customers and boost sales, merchants often launch sales promotion, in which coupon is an effective means for promoting sales. Merchants may distribute physical coupons, with which the customers may enjoy corresponding discounts.

With the development of internet technology, online shopping, online payment and so on have become an indispensable part in people's life. Redemption code is widely used in electronic commerce as a means for promotion. The redemption code is a code consisting of a group of letters and digits. Customers can redeem the redemption codes for corresponding goods on the web. The goods may be physical goods or virtual goods. The redemption code usually has a certain period of validity, and if the validity is expired, the redemption code becomes invalid.

At present, in dealing with redemption codes, it is common that the merchants establish individually redemption code systems which store the redemption codes, and send the redemption codes to the customers corresponding to customer information as stored, and that when the customers use the redemption codes, the redemption code system checks to see whether the redemption codes sent by a customer is a valid redemption code stored in the system, and if it is valid, the customer can enjoy the benefit corresponding to the redemption code. However, a large amount of redemption code data needs to be stored and distributed efficiently, and there is therefore a high requirement for the processing capability of the redemption code system. Accordingly, there is a need to provide an efficient method for storing and distributing redemption codes.

### SUMMARY

An object of the embodiments of the present disclosure is to provide a method, server and system for distributing redemption code, with which redemption codes can be efficiently stored and distributed.

The embodiments of this disclosure are implemented as follows.

Provided is a method for distributing a redemption code, comprising: receiving, by a server which comprises a plurality of sub-servers, a redemption code data sent by a merchant, which comprises a merchant identifier and redemption code characters; writing, by the server, the merchant identifier and the redemption code characters in the redemption code data into a first data table as a primary key; splitting, by the server, the first data table into a preset number of sub data tables, and storing the redemption code data in the first data table into the preset number of sub data tables, respectively; receiving, by the server, a distribution request from the merchant, and determining target customers based on the distribution request; allocating the distribution request and the sub data tables to the sub-servers evenly; and obtaining, by a respective one of the sub-servers, the redemption code data from a sub data table that corresponds to this sub-server in accordance with the distribution request, and distributing the obtained redemption code data to the target customers.

Provided is a system for distributing a redemption code, which includes a client and a server. The client is configured to send a redemption code data to the server and to send a distribution request to the server. The redemption code data includes a merchant identifier and redemption code characters. The distribution request includes a merchant identifier, a distribution time, a unique service serial number, and a target customer filtering rule. The server comprises a plurality of sub-servers. The server is configured to receive the redemption code data sent by the client, and write the merchant identifier and the redemption code characters in the redemption code data into a first data table as a primary key; split the first data table into a preset number of sub data tables, and store the redemption code data in the first data table into the preset number of sub data tables, respectively; and receive a distribution request sent by the client, determine target customers in accordance with the distribution request, and allocate the distribution request and the sub data tables to the sub-servers evenly. Each of the sub-servers is configured to obtain the redemption code data from a sub data table that corresponds to this sub-server in accordance with the distribution request, and distribute the redemption code data to the target customers.

Provided is a server including a redemption code data receiving module, a redemption code data storing module, a distribution request receiving module, a target customer determining module, and a redemption code data sending module. The redemption code data receiving module is configured to receive redemption code data sent by a merchant. The redemption code data includes a merchant identifier and redemption code characters. The redemption code data storing module is configured to write the merchant identifier and the redemption code characters in the redemption code data into a first data table as a primary key, and split the first data table into a preset number of sub data tables, store the redemption code data in the first data table into the preset number of sub data tables, respectively. The distribution request receiving module is configured to receive a distribution request sent by the merchant. The distribution request includes a merchant identifier, a distribution time, a unique service serial number, and a target customer filtering rule. The target customer determining module is configured to determine target customers according to the target customer filtering rule in the distribution request. The redemption code data sending module is configured to obtain the redemption code data from the sub data tables and distribute the redemption code data to the target customers.

As can be seen from the above, in one or more embodiments of the present disclosure, storage and distribution of redemption code data is implemented by a server provided by an e-commerce platform, multiple merchants can share server resources, thereby saving computer resources. In addition, the server determines the target customers based on the distribution request of the merchant, so as to expand the customer base of the merchant and amplify the benefit obtained by distributing redemption codes. It is also possible to split and store the redemption code data in a plurality of sub data tables, and allocate the plurality of sub data table evenly to the plurality of sub-servers to distribute the redemption code data, thereby improving the efficiency of the redemption code distribution.

### BRIEF DESCRIPTION OF DRAWINGS

In order to describe the technical solutions of the embodiments in the present disclosure or the prior art more clearly, the accompanying drawings for the embodiments or the prior art will be briefly introduced in the following. It is apparent that the accompanying drawings described in the following involve merely some embodiments disclosed in this disclosure, and those skilled in the art can derive other drawings from these accompanying drawings without creative efforts.

FIG. 1 is a flow chart of a method for distributing redemption code as provided in an embodiment of the present disclosure;

FIG. 2 is a flowchart of a method for distributing redemption code on the server side as provided in an embodiment of the present disclosure;

FIG. 3 is a block diagram of a hardware structure of a server as provided in an embodiment of the present disclosure;

FIG. 4 is a structural diagram of a system for distributing redemption code as provided in an embodiment of the present disclosure;

FIG. 5 is a schematic block diagram of a server as provided in an embodiment of the present disclosure;

FIG. 6 is a schematic diagram of module structure of a redemption code data storing module in the server as provided an embodiment of the present disclosure;

FIG. 7 is another schematic diagram of the server as provided in an embodiment of the present disclosure;

### DETAILED DESCRIPTION

Embodiments of the present disclosure provide a method, a server, and a system for distributing a redemption code.

In order to enable those skilled in the art to better understand the technical solutions in the present disclosure, the technical solutions of the embodiments in the present disclosure will be clearly and comprehensively described in the following with reference to the accompanying drawings. It is apparent that the embodiments as described are merely some, rather than all, of the embodiments of the present disclosure. All other embodiments obtained by those skilled in the art based on one or more embodiments described in the present disclosure without creative efforts should fall within the scope of this disclosure.

In one application scenario, a merchant needs to distribute redemption codes to a large number of users, and also needs to store those redemption codes before their distribution. Generally, a merchant system does not have the capability of storing and distributing a large amount of redemption codes. In another application scenario, a merchant may establish a redemption code system for distributing the redemption codes to independently implement its own redemption code promotion, but since the redemption code promotion is typically an event that is occasionally carried out according to a business strategy, the established redemption code system has a low utilization rate, which causes waste of resources and cost-up of the merchant. On the other hand, in the redemption code system established by the merchant, the target of redemption code distribution can only be existing customers of the merchant, therefore the redemption code promotion cannot be extended to more customers. Embodiments of the method for distributing redemption code as provided in this disclosure are intended to solve the above problems.

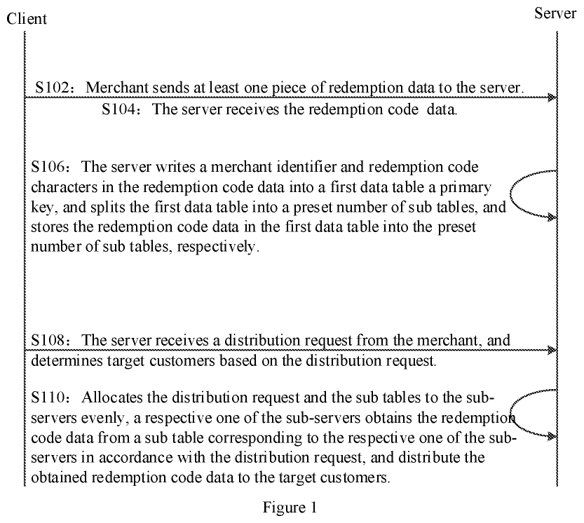

Hereinafter, a specific embodiment of a method for distributing redemption code of the present disclosure will be described. FIG. 1 is a flow chart of a method for distributing redemption code as provided in an embodiment of this disclosure. It is to be noted that although this disclosure provides operation steps as depicted in the embodiment or flowchart, more or fewer operation steps may be included as necessary without involving creative efforts. The order of the steps as described in the embodiments is merely one of many orders for performing the steps, and rather is not meant to be unique. In practical implementation in a system or an apparatus, the steps can be performed either in the order depicted in the embodiments or the drawings, or be performed in parallel (for example, in an environment of parallel processors or multi-thread processing). In particular, as shown in FIG. 1, the method may comprise the following steps.

S102: a merchant sends at least one piece of redemption code data to a server.

In one embodiment, the redemption code data may include a merchant identifier and redemption code characters. The redemption code data may further include a validity period of the redemption code.

The merchant identifier may uniquely identify the merchant. For example, it could be a merchant name or the like.

The redemption code characters may comprise at least one of letters, digits, words and symbols.

The validity period of the redemption code may indicate the valid time of the redemption code data.

In another embodiment, the redemption code data may further include an event name and/or a redemption code name.

The event name may indicate a marketing campaign corresponding to the redemption code characters. For example, the event name may be “Double Eleven Promotion,” “Double Twelve Promotion” or “Spring Festival Promotion”, etc.

The redemption code name may indicate a benefit associated with the redemption code characters. For example, the redemption code name may be “redemption code for Youku one-month membership”, “redemption code for OFO bicycle one-month membership”, and so on.

In one embodiment, the server may be a single server.

In another embodiment, the server may be a server cluster consisting of multiple sub-servers.

The merchant may send the redemption code data to the server. The redemption code data may include at least one piece of redemption code data.

S104: The server receives the redemption code data.

The server may receive the redemption code data.

In one embodiment, if the server is a server cluster composed of a plurality of sub-servers, the redemption code data may be received by one of the plurality of sub-servers.

S106: The server writes the merchant identifier and the redemption code characters in the redemption code data into a first data table as a primary key, the server splits the first data table into a preset number of sub data tables, and stores the redemption code data in the first data table into the preset number of sub data tables, respectively.

The server may store the redemption code data.

In one embodiment, the server may store the redemption code data according to the merchant identifier and redemption code characters in the redemption code data. Specifically, the server may write the merchant identifier and the redemption code characters in the redemption code data into the first data table as a primary key. By using the merchant identifier and the redemption code characters as the primary key, it is possible to ensure that the same redemption code characters from different merchants can coexist and that the redemption code characters of one merchant will not become duplicated.

In one embodiment, the server may further set a redemption code status for the redemption code data. The redemption code status may indicate whether or not the redemption code characters are usable. For example, the redemption code status may be In Reading, To be Distributed, or Distributed.

Among them, the redemption code status “In Reading” may indicate that all redemption code data of the marketing campaign corresponding to the current redemption code have not yet been read successfully, and the current redemption code is not usable. The redemption code status “To be Distributed” may indicate that the redemption code data is ready for distribution but yet to be distributed. The redemption code status “Distributed” may indicate that the redemption code data has been distributed to the customers.

In one embodiment, the first data table may be split into a preset number of sub data tables. Accordingly, the redemption code data in the first data table are stored in the preset number of sub data tables, respectively. The preset number may be preset. For example, it may be 10, 100, etc. When the server includes a plurality of sub-servers, once the first data table is split into a plurality of sub data tables, the distribution of the redemption code in the plurality of sub data tables can be assigned to the plurality of sub-servers, and the efficiency of distributing the redemption code can be improved.

In one embodiment, the preset number may be set based on the number of the sub-servers. For example, the preset number may be an integer multiple of the number of sub-servers.

In one embodiment, storing the redemption code data in the first data table into the preset number of sub data tables respectively may include setting a serial number for each of the sub data tables, calculating a character factor corresponding to the redemption code characters in the redemption code data, determining a first serial number based on the character factor and the preset number, and storing the redemption code data into the sub data table with the first serial number.

In one embodiment, calculating the character factor corresponding to the redemption code characters in the redemption code data may include any one of: calculating a hash value of the redemption code characters; calculating a MD5 (Message-Digest Algorithm 5) value of the redemption code characters; coding the redemption code characters into a binary code, and converting the binary code into a number.

In one embodiment, determining the first serial number based on the character factor and the preset number may specifically include obtaining a first serial number by having the character factor mod the preset number.

By calculating the character factor of the redemption code characters in each piece of redemption code data and determining a sub data table to store the redemption code data based on the character factor, it is ensured that the sub data table in which the redemption code characters are to be stored is definite. If a merchant provides redemption code data of the same redemption code characters at different times, the same redemption code data will be stored in the same sub data table so that duplicate redemption code characters can be detected.

Further, the server may establish a routing data table based on the sub data table. The routing data table may indicate the quantity distribution of the redemption code data corresponding to each merchant identifier in each sub data table. Establishing the routing data table may specifically include: the server counting the quantity of the redemption code data of each merchant in each sub data table, and establishing the routing data table based on the counting result.

Further, when a merchant involves a plurality of events, establishing the routing data table may specifically include counting, by the server, the number of the redemption code data corresponding to the event name and/or the redemption code name associated with each merchant in each sub data table, and establishing the routing data table based on the counting results.

Table 1 is an example of a routing data table in the embodiment of the present disclosure. In this example, there are 100 sub data tables, numbered as Table 00 to Table 99, respectively. The first column in this example is the merchant's redemption code name. The third column in this example is the quantity of redemption code data that have a name as indicated in the first column and that are included in the sub data table indicated by the number in the second column.

TABLE 1

| | No. of | quantity of |
|---|---|---|
| redemption code name | sub data table | redemption codes |
| Redemption code for OFO | Table_00 | 10000 |
| bicycle one-month membership | | |
| Redemption code for OFO | Table_01 | 9988 |
| bicycle one-month membership | | |
| Redemption code for OFO | . . . | . . . |
| bicycle one-month membership | | |
| Redemption code for OFO | Table_99 | 10013 |
| bicycle one-month membership | | |
| Redemption code for | Table_00 | 5002 |
| Youku one-month membership | | |
| Redemption code for | Table_01 | 4989 |
| Youku one-month membership | | |
| Redemption code for | . . . | . . . |
| Youku one-month membership | | |
| Redemption code for | Table_99 | 5001 |
| Youku one-month membership | | |

Step S108: The server receives a distribution request sent by the merchant, and determines target customers based on the distribution request.

The server may receive a distribution request from the merchant.

In one embodiment, the distribution request may include a merchant identifier, a distribution time, a unique service serial number, a target customer filtering rule.

The distribution time may indicate the time for distributing the redemption code data corresponding to the merchant identifier.

The unique service serial number may uniquely identify the distribution request. It may be used to check whether the currently received distribution request is a duplicate distribution request.

The target customer filtering rule may be used to filter the target customers.

In another embodiment, the distribution request may further include an event name and/or a redemption code name, when a single merchant contains redemption codes corresponding to a plurality of events.

The server may determine the target customers according to the target customer filtering rule in the distribution request.

In one embodiment, the target customer filtering rule may be associated with target customer identifiers. Determining, by the server, the target customers according to the target customer filtering rule may be such that the server takes the customers corresponding to the target customer identifiers as the target customers.

In one embodiment, the target customer filtering rule may be associated with a preset filtering condition. For example, the filtering condition may be: target customers should be customers aging from 20 to 30, or should be female customers, etc. Determining, by the server, the target customers according to the target customer filtering rule may be such that the server takes the customers meeting the preset filtering condition as the target customers.

In one embodiment, the target customer filtering rule may be associated with customers who request to obtain redemption code data. For example, a promotion link for obtaining the redemption code data may be sent to all customers, and some customers who are willing to obtain the redemption code data may send a request for obtaining the redemption code data according to the promotion link. Therefore determining, by the server, the target customers according to the target customer filtering rule may be such that the server takes the customers having sent the request to obtain the redemption code data as the target customers.

With the target customer filtering rule, it is possible to filter out the target customers to be distributed with the redemption code data, therefore the customers to be distributed with the redemption code by the merchant will not be limited to users who have been registered by the merchant, and more customers may participate in the redemption code event, thereby improving the efficiency of the sales promotion.

S110: the distribution request and the sub data tables are evenly allocated to the sub-servers, and a respective one of the sub-servers obtains redemption code data from the sub data tables corresponding to this sub-server based on the distribution request, and distribute the redemption code data to the target customers.

After determining the target customers, the server may distribute redemption code data to the target customers.

In one embodiment, after distributing the redemption code data to the target customers, the server may set, for the redemption code data, a “distribution completed” flag. The “distribution completed” flag may indicate that the redemption code data has been distributed in order to prevent the same redemption code data from being repeatedly distributed to different users.

In one embodiment, the server distributes a redemption code to the target customers, in particular, the distribution request and the sub data tables may be evenly allocated to at least one of the sub-servers, which obtains redemption code data from the sub data table corresponding to itself in accordance with the distribution request, and distributes the redemption code data to the target customers.

Further, the method may further comprise that, after the distribution of the redemption code data for the merchant in the sub data table corresponding to the sub-server is completed, the sub-server may update the routing data table according to the already distributed redemption code data. Specifically, after every piece of redemption code data corresponding to the merchant identifier in the sub data table corresponding to the sub-server is set with the “distribution completed” flag, the routing data table may be updated with the data in the sub data table.

Updating the routing data table using the data in the sub data table may specifically include setting a “distributed” flag for the data corresponding to the merchant and the sub data table in the routing data table. Referring to Table 2, Table 2 is an example of the routing data table after the “Redemption code for OFO bicycle one-month membership” in the sub data tables “Table 00” and “Table 01” of Table 1 are distributed and the routing data table is updated.

TABLE 2

| | Sub-data | quantity of | “distribution |
|---|---|---|---|
| redemption code name | serial No | redemption codes | completed” flag |
| Redemption code for OFO | Table_00 | 10000 | 1 |
| bicycle one-month membership | | | |
| Redemption code for OFO | Table_01 | 9988 | 1 |
| bicycle one-month membership | | | |
| Redemption code for OFO | . . . | . . . | 0 |
| bicycle one-month membership | | | |
| Redemption code for OFO | Table_99 | 10013 | 0 |
| bicycle one-month membership | | | |
| Redemption code for | Table_00 | 5002 | 0 |
| Youku one-month membership | | | |
| Redemption code for | Table_01 | 4989 | 0 |
| Youku one-month membership | | | |
| Redemption code for | . . . | . . . | 0 |
| Youku one-month membership | | | |
| Redemption code for | Table_99 | 5001 | 0 |
| Youku one-month membership | | | |

By evenly allocating the sub data tables and the distribution request to the plurality of sub-servers, it is possible to realize simultaneous distribution of the plurality of redemption code data in parallel, and the efficiency of the distribution of the redemption code data can be improved.

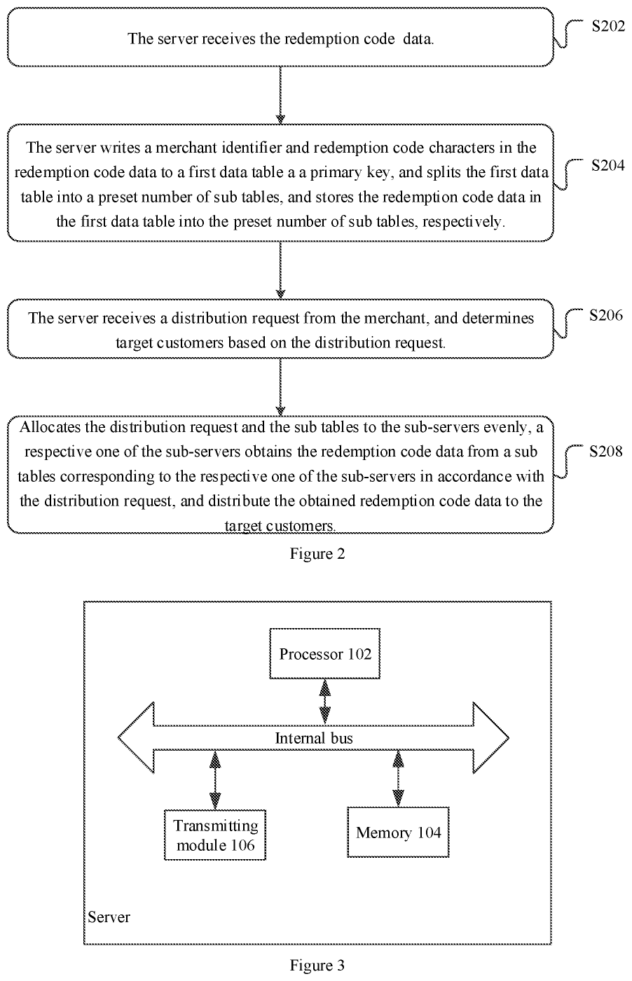

Based on the method for distributing redemption code provided by the above embodiment, this disclosure also provides an embodiment of method for distributing redemption code on the server side. FIG. 2 is a flowchart of the method for distributing redemption code on the server side provided in one embodiment of this disclosure. Referring to FIG. 2, the method may include the following steps.

S202: The server receives a redemption code data sent by a merchant.

The server may receive the redemption code data sent by the merchant.

In one embodiment, that redemption code data may include a merchant identifier and redemption code characters. The redemption code data may further include a validity period of the redemption code.

In another embodiment, the redemption code data may further include an event name and/or a redemption code name.

The server may be a single server. The server may also be a server cluster composed of a plurality of sub-servers.

When the server is a server cluster composed of a plurality of sub-servers, the redemption code data may be received by one of the plurality of sub-servers.

S204: The server writes the merchant identifier and the redemption code characters in the redemption code data into a first data table as a primary key, and the server splits the first data table into a preset number of sub data tables, stores the redemption code data in the first data table into the preset number of sub data tables, respectively.

The server may store the redemption code data.

In one embodiment, the server may store the redemption code data according to the merchant identifier and redemption code characters in the redemption code data. Specifically, the server may write the merchant identifier and the redemption code characters in the redemption code data into the first data table as a primary key.

The server may further set a redemption code status for the redemption code data. The redemption code status may indicate whether or not the redemption code characters are usable. For example, the redemption code status may be In Reading, To be Distributed, or Distributed.

In one embodiment, the first data table may be split into a preset number of sub data tables. Accordingly, the redemption code data in the first data table are stored in the preset number of sub data tables, respectively. The preset number may be preset.

In one embodiment, the preset number may be set according to the number of the sub-servers.

In one embodiment, storing the redemption code data in the first data table into the preset number of sub data tables respectively may include setting a serial number for each of the sub data tables, calculating a character factor corresponding to the redemption code characters in the redemption code data, determining a first serial number based on the character factor and the preset number, and storing the redemption code data into the sub data table with the first serial number.

In one embodiment, calculating the character factor corresponding to the redemption code characters in the redemption code data may include any one of: calculating a hash value of the redemption code characters; calculating a MD5 (Message-Digest Algorithm 5) value of the redemption code characters; coding the redemption code characters into a binary code, and converting the binary code into a number.

In one embodiment, determining the first serial number based on the character factor and the preset number may specifically include obtaining a first serial number by having the character factor mod the preset number.

Further, the server may establish a routing data table based on the sub data table. The routing data table may indicate the quantity distribution of the redemption code data corresponding to each merchant identifier in each sub data table. Establishing the routing data table may specifically include: the server counting the quantity of the redemption code data of each merchant in each sub data table, and establishing the routing data table based on the counting result.

Further, when a merchant involves a plurality of events, establishing the routing data table may specifically include counting, by the server, the number of the redemption code data corresponding to the event name and/or the redemption code name of each merchant in each sub data table, and establishing the routing data table based on the counting result.

S206: the server receives a distribution request sent by a merchant, and determines target customers based on the distribution request.

In one embodiment, the distribution request may include a merchant identifier, a distribution time, a unique service serial number, a target customer filtering rule.

In another embodiment, the distribution request may further include an event name and/or a redemption code name, when a single merchant is associated with redemption codes corresponding to a plurality of events.

The server may determine the target customers according to the target customer filtering rule in the distribution request.

In one embodiment, the target customer filtering rule may be associated with target customer identifiers. Determining, by the server, the target customers according to the target customer filtering rule may be such that the server takes the customers corresponding to the target customer identifiers as the target customers.

In one embodiment, the target customer filtering rule may be associated with a preset filtering condition. Determining, by the server, the target customers according to the target customer filtering rule may be such that the server takes the customers meeting the preset filtering condition as target customers.

In one embodiment, the target customer filtering rule may be associated with customers who request to obtain redemption code data. The server determining the target customer according to the target customer filtering rule may be such that the server takes the customers having sent the request to obtain the redemption code data as target customers.

S208: The distribution request and the sub data tables are evenly allocated to the sub-servers, and the sub-servers obtain redemption code data from the sub data tables corresponding to the sub-servers based on the distribution request, and distribute the redemption code data to the target customers.

In one embodiment, after distributing the redemption code data to the target customers, the server may set a “distribution completed” flag for the redemption code data. The “distribution completed” flag may indicate that the redemption code data has been distributed in order to prevent the same redemption code data from being repeatedly distributed to different users.

In one embodiment, after distributing the redemption code data to the target customers, the server may set a “distribution completed” flag for the redemption code data.

Further, the method may further comprise that, after the distribution of the redemption code data for the merchant in the sub data table corresponding to the sub-server is completed, the sub-server may update the routing data table according to the already distributed redemption code data. Specifically, after every piece of redemption code data corresponding to the merchant identifier in the sub data table corresponding to the sub-server is set with the “distribution completed” flag, the routing data table may be updated with the data in the sub data table.

Updating the route data table using the data in the sub data table may specifically include setting a “distribution completed” flag for the data corresponding to the merchant and the sub data table in the routing data table.

In the embodiments of this disclosure, storage and distribution of redemption code data is implemented by a server provided by an e-commerce platform, multiple merchants can share the server resources, thereby saving computer resources. In addition, the server determines the target customers based on the distribution request from the merchant, so as to expand the customer base of the merchant and amplify the benefit obtained by distributing redemption code. In the embodiment provided in this disclosure, the redemption code data may be split into a plurality of sub data tables and stored therein, and the plurality of sub data tables may be evenly allocated to the plurality of sub-servers for distributing the redemption code data, thereby improving the efficiency of the redemption code distribution.

The method embodiments provided in the embodiments of the present application may be implemented in a mobile terminal, a computer terminal, a server, or a similar computing device. Taking server implementation as an example, FIG. 3 is a block diagram of a hardware structure of a server in an embodiment of the present disclosure. As shown in FIG. 3, the server may include one or more (only one shown in the figure) processors 102, a memory 104 for storing data, and a transmitting module 106 for communication.

The processor 102 may include a central processing unit (CPU) or a graphics processor (GPU), but may also include other devices having logic processing capabilities, such as single-chip microcomputers, logic gates, integrated circuits, and the like, or suitable combinations thereof.

The memory 104 may store software programs and modules of application software, such as program instructions/modules corresponding to search methods in embodiments of the present disclosure. The processor 102 executes various functional applications and data processing by running the software programs and modules stored in memory 104, that is, to realize the above-mentioned method. The memory 104 may include high-speed random access memory, and may also include non-volatile memory, such as one or more magnetic storage devices, flash memories, or other non-volatile solid state memories. In some examples, the memory 104 may further include memory remotely disposed with respect to the processor 102, which may be connected to the computer terminal 10 via a network. Examples of such network include, but are not limited to, the Internet, an intranet, a local area network, a mobile communication network, and combinations thereof. In implementation, the memory may also take the form of cloud memory, and the specific implementation is not limited in this disclosure.

The transmitting module 106 may be configured to receive or transmit data via a network. A specific example of the network as described above may include a wireless network provided by a communication provider. In one example, the transmitting module 106 includes a Network Interface Controller (NIC), which may be connected to other network devices through a base station so as to communicate with the Internet. In one example, the transmitting module 106 may be a Radio Frequency (RF) module for communicating with the Internet wirelessly.

Those skilled in the art will appreciate that the structure shown in FIG. 3 is merely schematic and does not limit the structure of the server described above. For example, the server may include more or fewer components than those shown in FIG. 3, for example, it may include other processing hardware, such as a GPU (Graphics Processing Unit), or has a different configuration than that shown in FIG. 3.

Based on the methods described above, the present disclosure also provides a system and a server. The system and server may include an apparatus comprising a system (including a distributed system), software (application), modules, components, devices, etc., that implements the method described of the embodiments in the present disclosure, in conjunction with necessary hardware. Based on the same inventive concept, the system and server are provided in this disclosure as described in the following embodiments. Because the technical solution of the server is similar to that of the method, for specific implementations of the system and server in the present disclosure, reference can be made to implementation of the method mentioned above, and excessive details are omitted here. Although the device described in the following embodiments is preferably implemented as software, implementation of hardware or a combination of software and hardware may also be conceived.

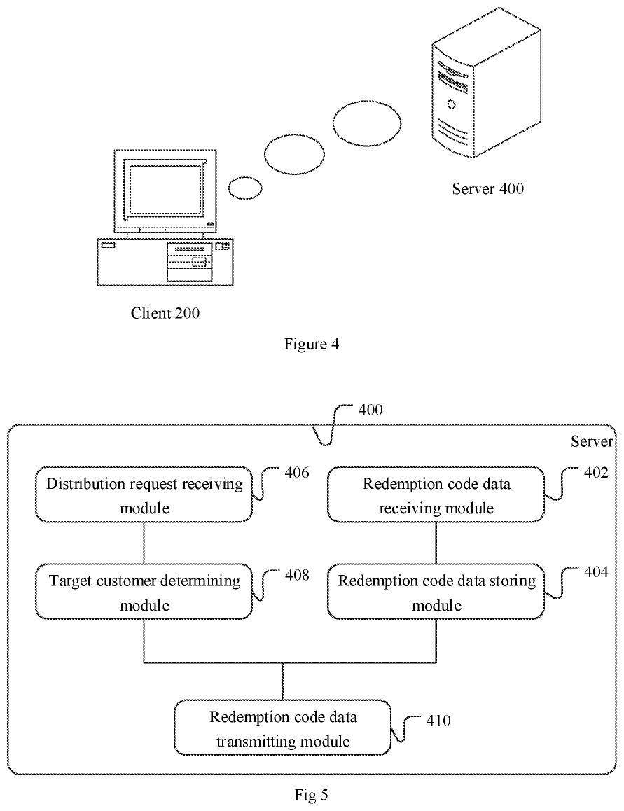

FIG. 4 is a system structure diagram of the system for distributing redemption code of an embodiment provided in this disclosure. As shown in FIG. 4, the system for distributing redemption code may include a client 200 and a server 400.

The client 200 may be a client at merchant side.

The client 200 may be configured to send a redemption code data to the server and send a distribution request to the server.

The redemption code data may include a merchant identifier and redemption code characters. The redemption code data may further include a validity period of the redemption code.

The distribution request includes a merchant identifier, a distribution time, a unique service serial number, and a target customer filtering rule.

The server 400 may be a server provided by an e-commerce platform. The server 400 may include a plurality of sub-servers.

The server 400 may be configured to receive the redemption code data sent by the client, and write the merchant identifier and the redemption code characters in the redemption code data into a first data table as a primary key, split the first data table into a preset number of sub data tables, and store the redemption code data in the first data table into the preset number of sub data tables, respectively; and may be configured to receive a distribution request sent by the client, determine target customers based on the distribution request, and allocate the distribution request and sub data table to the sub-servers evenly, a respective one of the sub-servers obtains the redemption code data from the sub data tables corresponding to this sub-server in accordance with the distribution request, and distribute the redemption code data to the target customers.

In one embodiment, after distribution of the redemption code data to the target customers, the server 400 may further set a “distribution completed” flag for the distributed redemption code data.

FIG. 5 is a schematic block diagram of a server provided in an embodiment of this disclosure. Referring to FIG. 5, the server 400 may include a redemption code data receiving module 402, a redemption code data storing module 404, a distribution request receiving module 406, a target customer determining module 408 and a redemption code data transmitting module 410.

The redemption code data receiving module 402 may be configured to receive redemption code data sent by a merchant; the redemption code data includes a merchant identifier and redemption code characters. The redemption code data may further include a validity period of the redemption code.

The redemption code data storing module 404 may be configured to write the merchant identifier and the redemption code characters in the redemption code data into a first data table as a primary key, and split the first data table into a preset number of sub data tables, store the redemption code data in the first data table into the preset number of sub data tables, respectively.

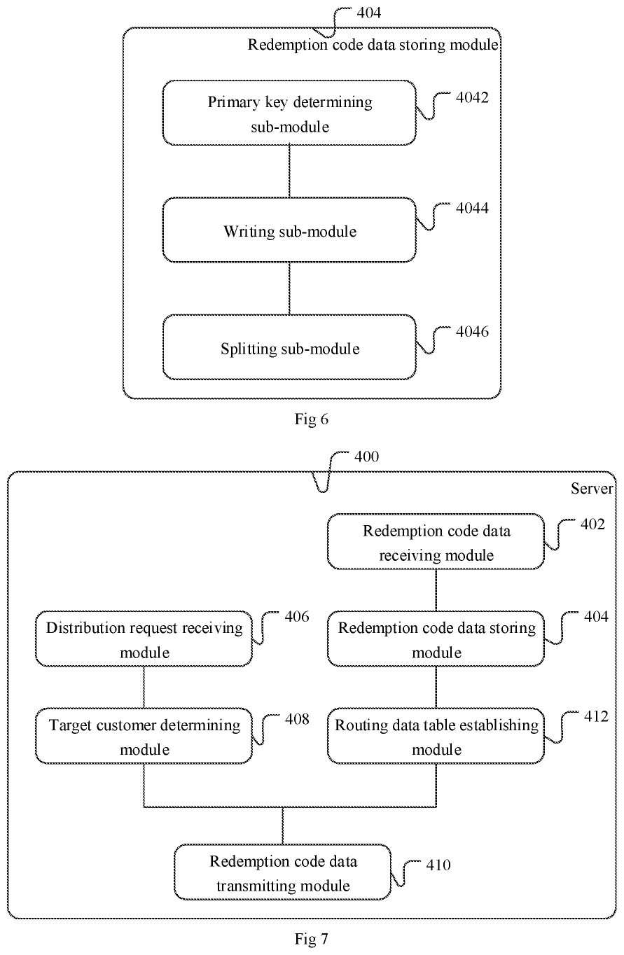

FIG. 6 is a schematic diagram showing structure of the redemption code data storing module in the embodiment of the server as provided in this disclosure. Referring to FIG. 6, the redemption code data storing module 404 includes a primary key determining sub-module 4042, a writing sub-module 4044, and a splitting sub-module 4046.

The primary key determining sub-module 4042 may be configured to determine the merchant identifier and the redemption code characters in the redemption code data as a primary key.

The writing sub-module 4044 may be configured to write the redemption code data into the first data table according to the primary key.

The splitting module 4046 may be configured to split the first data table into a preset number of sub data tables, and store the redemption code data in the first data table into the preset number of sub data tables.

The distribution request receiving module 406 may be configured to receive a distribution request sent by a merchant. The distribution request may include a merchant identifier, a distribution time, a unique service serial number, and a target customer filtering rule.

The target customer determining module 408 may be configured to determine the target customers according to the target customer filtering rule in the distribution request.

The redemption code data sending module 410 may be configured to obtain redemption code data from the sub data tables and distribute the redemption code data to the target customers.

FIG. 7 is another schematic diagram of a server embodiment provided in this disclosure. Referring to FIG. 7, in this embodiment, the server 400 may further include a routing data table establishing module 412, which may be configured to establish a routing data table based on the sub data tables. The routing data table may indicate the quantity distribution of the redemption code data corresponding to each merchant identifier in each sub data table.

In another embodiment, the server may be a server cluster composed of a plurality of sub-servers. Then, the server may further include an equalizing module (not shown in both FIG. 5 and FIG. 7) that may be configured to evenly allocate the distribution request and the sub data tables to the sub-servers.

In another embodiment, the server may further include a distribution flag setting module (not shown in both FIG. 5 and FIG. 7) that may be configured to set a “distribution completed” flag for the redemption code data which have been distributed to the target customers after the distribution of the redemption code data.

The method or apparatus provided in the embodiments of the present disclosure may be implemented by a processor executing corresponding program instructions in a computer. For instance, the method or apparatus may be implemented in a PC by using a C++ language in a Windows operating system, or implemented in a smart terminal by using an appropriate program designing language in Android or iOS system, or implemented on the basis of process logic of a quantum computer.

In particular, another aspect of the present disclosure also provides a server comprising a processor and a memory storing computer program instructions executed by the processor, the execution of the computer program instructions implementing the steps of: receiving, by the server, the redemption code data sent by a merchant, the redemption code data including a merchant identifier and redemption code characters, the server comprising a plurality of sub-servers; writing, by the server, the merchant identifier and the redemption code characters in the redemption code data into a first data table as a primary key; splitting, by the server, the first data table into a preset number of sub data tables, storing the redemption code data in the first data table into the preset number of sub data tables, respectively; receiving, by the server, a distribution request from the merchant, and determining target customers based on the distribution request, evenly allocating the distribution request and the sub data tables to the sub-servers; and obtaining, by a respective one of the sub-servers, the redemption code data from the sub data tables corresponding to this sub-server in accordance with the distribution request, and distributing the redemption code data to the target customers.

As can be seen, the embodiments of system and server for distributing redemption code provided in this disclosure are based on the same inventive concept as the method embodiments in this disclosure, and therefore, the embodiments of system and server for distributing redemption code provided in this disclosure may achieve the same technical effects as the method embodiments.

Particular embodiments of the present disclosure have been described above. There may be other embodiments which fall within the scope of the appended claims. Under some circumstances, the actions or steps included in the claims may be performed in an order different from that described in the embodiments and the desired result can still be achieved in this case. In addition, the processes depicted in the drawings do not have to be performed in the specific order as depicted or performed in a consecutive sequence to achieve the desired result. In some embodiments, multitask processing and parallel processing are also possible or may be advantageous.

In the 1990s, it is easy to tell whether a technical improvement is a hardware improvement (for example, an improvement to a circuit structure such as a diode, a transistor, a switch, etc.), or a software improvement (an improvement to a methodical process). However, with the development of technologies, many improvements to methodical processes nowadays can be regarded as improvements to the hardware circuit structures. Basically, all improved methodical processes can be programmed into a hardware circuit to obtain corresponding hardware circuit structures. Therefore, it cannot be ruled out to implement an improvement to a methodical process with a physical hardware module. For example, a Programmable Logic Device (PLD) (e.g., Field Programmable Gate Array (FPGA)) is an integrated circuit of which logical functions are determined by user's programming of the device. The designer programs by himself to “integrate” a digital system into a piece of PLD, without needing to design and manufacture the ASIC chip by a chip manufacturer. Moreover, at present, instead of manually manufacturing the integrated circuit chips, such programming is mostly implemented by using software “logic compiler”, which is similar to the software compiler used for program development, and the source codes to be compiled should be written in a specific programming language referred to as Hardware Description Language (HDL). There are many kinds of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc., and currently the most commonly used is Very-High-Speed Integrated Circuit Hardware Description Language (VHDL) and Verilog. It is comprehensible to those skilled in the art that a hardware circuit that implements a methodical process can be easily obtained by adequately programming the methodical process into an integrated circuit with the aforementioned hardware description languages.

The controller may be implemented in any suitable way. For example, the controller may take the form of, for instance, a microprocessor or processor, and a computer readable medium storing computer readable program codes (e.g., software or firmware) executable by the (micro) processor, a logic gate, a switch, an application-specific integrated circuit (ASIC), a programmable logic controller, and an embedded microcontroller. Examples of the controller include, but not limited to, the microcontrollers such as ARC 625D, Atmel AT91SAM, Microchip PIC18F26K20, and Silicone Labs C8051F320. A memory controller may also be implemented as a part of control logic of the memory. As known to those skilled in the art, in addition to implementing the controller in the form of the pure computer readable program codes, it is definitely possible to embody the method in a program to enable a controller to implement the same functionalities in the form of such as a logic gate, a switch, an application-specific integrated circuit, a programmable logic controller, or an embedded microcontroller. Thus, such a controller may be regarded as a hardware component, while means included therein for implementing respective functions may be regarded as parts in the hardware component. Furthermore, the means for implementing respective functions may be regarded as both software modules that implement the method and parts in the hardware component.

The apparatus, modules or units described in the foregoing embodiments can be implemented by a computer chip or entity, or implemented by a product having a specific function. A typical device implementation is a computer. Specifically, the computer can be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, an apparatus is divided into units by functionalities to be described respectively. However, in practical implementation, the function of one unit may be implemented in a plurality of software and/or hardware entities, or vice versa, the functions of a plurality of units may be implemented in a single software and/or hardware entity.

Those skilled in the art should understand that the embodiments of the present disclosure can be provided as a method, a device, or a computer program product. Therefore, the embodiments of the present disclosure may be implemented in a form of an absolute hardware embodiment, an absolute software embodiment, or an embodiment combining software and hardware. Moreover, the embodiments of the present disclosure can be in the form of a computer program product implemented on one or more computer usable storage medium (including, but not limited to, a magnetic disk memory, a CD-ROM, an optical memory and the like) including computer program codes.

The present invention has been described with reference to flowcharts and/or block diagrams of the method, device (apparatus) and computer program product of the embodiments in this disclosure. It should be understood that each process and/or block in the flowcharts and/or block diagrams and combinations of processes and/or blocks in the flowcharts and/or block diagrams can be implemented by computer program instructions. The computer program instructions may be provided to a general-purpose computer, a special-purpose computer, an embedded processor or a processor of other programmable data processing devices to form a machine, so that instructions executed by the computer or the processor of other programmable data processing devices form an apparatus configured to implement functions designated in one or more processes in a flowchart and/or one or more blocks in a block diagram.

The computer program instructions may also be stored in a computer readable memory which can guide the computer or other programmable data processing devices to operate in a specific manner, so that the instruction stored in the computer readable memory forms an article of manufacture comprising therein an instructing device, which implements functions designated in one or more processes in a flowchart and/or one or more blocks in a block diagram.

The computer program instructions may also be loaded onto a computer or other programmable data processing devices, so that a series of operational steps are performed on the computer or other programmable devices to form a computer implemented process, and therefore, the instructions executed in the computer or other programmable devices provide steps for implementing functions designated in one or more processes in a flowchart and/or one or more blocks in a block diagram.

In a typical configuration, the computing device includes one or more central processing units (CPUs), an input/output interface, a network interface, and a memory.

The memory may include computer readable medium such as a volatile memory, a Random Access Memory (RAM), and/or non-volatile memory, e.g., a Read-Only Memory (ROM) or a flash RAM. The memory is an example of a computer readable medium.

The computer readable medium includes non-volatile and volatile medium as well as removable and non-removable medium, and can implement information storage by any method or technology. The information can be a computer readable instruction, a data structure, a program module or other data. An example of the storage medium of a computer includes, but is not limited to, a phase change memory (PRAM), a static random access memory (SRAM), a dynamic random access memory (DRAM), other types of RAM, a ROM, an electrically erasable programmable read-only memory (EEPROM), a flash memory or other memory technologies, a compact disk read-only memory (CD-ROM), a digital versatile disc (DVD) or other optical storage devices, a cassette tape, a magnetic tape/magnetic disk storage device, a graphene storage device or other magnetic storage devices, or any other non-transmission medium, and can be used to store information accessible to the computing device. According to the definition in this context, the computer readable medium does not include transitory media, such as a modulated data signal and a carrier wave.

It is to be comprehended that, the terms “comprise”, “include” or any other variant thereof do not mean to be exclusive in that a process, a method, a product or a device comprising or including a number of elements may comprise or include not only those elements, but also other elements not explicitly listed, or may further comprise or include elements inherent to such process, method, product or device. It is not excluded that a process, method, product or device comprising an element may further comprise other elements, if not specifically prescribed.

Those skilled in the art should understand that the embodiments of the present disclosure can be provided as a method, a device, or a computer program product. Therefore, the embodiments of the present disclosure may be implemented in a form of an absolute hardware embodiment, an absolute software embodiment, or an embodiment combining software and hardware. Moreover, the embodiments of the present disclosure can be in the form of a computer program product implemented on one or more computer usable storage medium (including, but not limited to, a magnetic disk memory, a CD-ROM, an optical memory and the like) including computer program codes.

The present disclosure can be described in a general context of a computer executable instruction executed by a computer, for example, a program module. Generally, the program module may include a routine, a program, an object, a component, a data structure, and the like for performing a specific task or implementing a specific abstract data type. The present disclosure may also be implemented in a distributed computing environment. In the distributed computing environment, a task is performed by remote processing devices connected via a communication network. Further, in the distributed computing environment, the program module may be located in local and remote computer storage medium including a storage device.

The embodiments in the present disclosure are described in a progressive manner, which means descriptions of each embodiment are focused on the differences from other embodiments, and the descriptions of the same or similar aspects of the embodiments are applicable to each other. In particular, for the embodiments involving apparatus and server, of which essence is analogous to that of the method embodiments, reference can be made to the method embodiments, and detailed description may be omitted.

The above descriptions involve merely some embodiments of the present disclosure, and are not intended to limit the present disclosure. Various modifications and variations may be made to the embodiments of the present disclosure by those skilled in the art. Any modifications, equivalents, improvements, and the like made within the spirit and principle of the present disclosure shall fall within the scope of the appended claims.

What is claimed is:

1. A method for distributing a redemption code, comprising:
receiving, by a server, a redemption code data sent by a merchant, wherein said redemption code data comprise a merchant identifier and redemption code characters, said server comprises a plurality of sub-servers;
writing, by said server, the merchant identifier and the redemption code characters in said redemption code data into a first data table as a primary key;
splitting, by said server, said first data table into a preset number of sub data tables, and storing the redemption code data in said first data table into said preset number of sub data tables, respectively;
receiving, by said server, a distribution request sent by said merchant, and determining target customers based on said distribution request;
allocating said distribution request and said sub data tables to said sub-servers evenly; and
obtaining, by a respective one of said sub-servers, the redemption code data from a sub data table that corresponds to said respective one of said sub-servers in accordance with said distribution request, and distributing the obtained redemption code data to said target customers.

2. The method according to claim 1, wherein storing the redemption code data in said first data table into said preset number of sub data tables respectively comprises:
setting serial numbers for said sub data tables;
calculating a character factor corresponding to the redemption code characters in said redemption code data;
determining a first serial number based on said character factor and the preset number; and
storing said redemption code data into a sub data table with the first serial number.

3. The method according to claim 2, wherein calculating the character factor corresponding to the redemption code characters in said redemption code data comprises any one of:
calculating a hash value of said redemption code characters;
calculating a Message-Digest algorithm 5 value of said redemption code characters;
coding said redemption code characters into a binary code, and converting said binary code into a number.

4. The method according to claim 2, wherein determining the first serial number based on said character factor and the preset number comprises obtaining the first serial number by having said character factor mod said preset number.

5. The method according to claim 1, further comprising establishing, by said server, a routing data table according to said sub data tables, wherein said routing data table indicates the quantity distribution of the redemption code data corresponding to each merchant identifier in each of the sub data tables.

6. The method according to claim 5, wherein establishing the routing data table comprises counting, by the server, the number of the redemption code data of each merchant in each of the sub data tables, and establishing the routing data table based on the result of the counting.

7. The method according to claim 5, wherein after distribution of the redemption code data of said merchants in the sub data table corresponding to said respective one of said sub-servers is completed, the method further comprises updating, by said respective one of said sub-server, said routing data table based on the distributed redemption code data.

8. The method according to claim 1, wherein said distribution request comprises a merchant identifier, a distribution time, a unique service serial number, and a target customer filtering rule.

9. The method according to claim 8, wherein the target customer filtering rule is associated with a target customer identifier, a preset filtering condition, and/or a customer who sends a request for acquiring redemption code data.

10. The method according to claim 1, wherein after said server distributes the redemption code data to said target customers, the method further comprises setting, by said server, a flag indicating completion of distribution for the distributed redemption code data.

11. A system for distributing a redemption code including a client and a server, wherein said client is configured to send redemption code data to said server and to send a distribution request to said server, wherein said redemption code data comprises a merchant identifier and redemption code characters, and said distribution request comprises a merchant identifier, a distribution time, a unique service serial number, and a target customer filtering rule,
wherein said server comprises a plurality of sub-servers, and said server is configured to
receive the redemption code data sent by said client, and write the merchant identifier and the redemption code characters in said redemption code data into a first data table as a primary key;
split said first data table into a preset number of sub data tables, and store the redemption code data in said first data table into said preset number of sub data tables, respectively; and
receive a distribution request sent by said client, determine target customers based on said distribution request, and allocate said distribution request and said sub data table to said sub-servers evenly,
wherein a respective one of said sub-servers is configured to obtain redemption code data from a sub data table that corresponds to the respective one of said sub-servers in accordance with said distribution request, and distribute the obtained redemption code data to said target customers.

12. The system according to claim 11, wherein said server is further configured to set, after the redemption code data is distributed to said target customers, a flag indicating completion of distribution for the distributed redemption code data.

13. A server comprising a redemption code data receiving module, a redemption code data storing module, a distribution request receiving module, a target customer determining module and a redemption code data sending module, wherein,
said redemption code data receiving module is configured to receive a redemption code data sent by a merchant, wherein said redemption code data includes a merchant identifier and redemption code characters;
said redemption code data storing module is configured to write the merchant identifier and the redemption code characters in said redemption code data into a first data table as a primary key, and split said first data table into a preset number of sub data tables, store the redemption code data in said first data table into said preset number of sub data tables, respectively;
said distribution request receiving module is configured to receive a distribution request sent by the merchant, wherein the distribution request comprises a merchant identifier, a distribution time, a unique service serial number and a target customer filtering rule;
said target customer determining module is configured to determine target customers according to the target customer filtering rule in said distribution request;
said redemption code data sending module is configured to obtain redemption code data from said sub data table and distribute the redemption code data to said target customers.

14. The server according to claim 13, wherein said server further comprises a routing data table establishing module, which is configured to establish a routing data table based on said sub data table, wherein said routing data table indicates the quantity distribution of the redemption code data corresponding to each merchant identifier in each one of the sub data tables.

15. The server according to claim 13, wherein said server comprises a plurality of sub-servers, and said server further comprises an equalizing module configured to allocate said distribution request and said sub data tables to said plurality of sub-servers evenly.

16. The server according to claim 13, wherein said server further comprises a distribution flag setting module, which is configured to set, after the redemption code data is distributed to said target customers, a flag indicating completion of distribution for the distributed redemption code data.
